(19) United States
(12) Patent Application Publication
(10) Pub. No.: US 2021/0357285 A1
(43) Pub. Date: Nov. 18, 2021

(54) Program Generation Apparatus and Parallel Arithmetic Device

(71) Applicant: Hitachi, Ltd., Tokyo (JP)

(72) Inventors: Hiroaki ITSUJI, Tokyo (JP); Takumi UEZONO, Tokyo (JP); Kenichi SHIMBO, Tokyo (JP); Tadanobu TOBA, Tokyo (JP)

(21) Appl. No.: 17/246,940

(22) Filed: May 3, 2021

(30) Foreign Application Priority Data
May 13, 2020 (JP) 2020-084388

(51) Int. Cl. G06F 11/07; G06F 7/57

(52) U.S. Cl. CPC G06F 11/0775; G06F 7/57; G06F 8/44; G06F 11/0751; G06F 11/0721

(57) ABSTRACT

A program for causing a parallel arithmetic device including a plurality of arithmetic groups to execute parallel arithmetic is input. The program includes information defining each of the following: application arithmetic constituting predetermined processing; redundant arithmetic (which is redundant arithmetic of the application arithmetic and is arithmetic assigned to a surplus core(s) in a diagnosis target arithmetic group); and diagnostic arithmetic (arithmetic that is a comparison of results of the same redundant arithmetic by two or more diagnosis target arithmetic groups and is assigned to surplus cores in an arithmetic group for diagnosis). The surplus core(s) is a core(s) to which no application arithmetic is assigned.

### CROSS-REFERENCE TO PRIOR APPLICATION

This application relates to and claims the benefit of priority from Japanese Patent Application number 2020-84388, filed on May 13, 2020 the entire disclosure of which is incorporated herein by reference.

### BACKGROUND

The present invention generally relates to detection of errors in a parallel arithmetic device.

In recent years, an AI function is incorporated into equipment on an edge side (for example, automobiles or industrial equipment) in place of or in addition to equipment on a cloud side.

In general, the AI (Artificial Intelligence) function is implemented by a GPU (Graphics Processing Unit) which is an example of the parallel arithmetic device (a device capable of parallel arithmetic). Accuracy of inference by the Al function also depends on accuracy of the GPU which performs the inference in addition to accuracy of inference models. Elements in the GPU can be roughly divided into a data system and a control system.

As a method for detecting errors in the data system, it is possible to adopt an error detection using redundant codes (for example, ECC [Error Correcting Code] and CRC [Cyclic Redundancy Code]).

On the other hand, as a method for detecting errors in the control system, it is possible to adopt redundancy (for example, duplication) of hardware resources including the control system. However, this method requires many hardware resources.

In order to avoid the redundancy of the hardware resources including the control system, a method disclosed in Reference 1, that is, a method for embedding a code for arithmetically operating a signature representing an arithmetic history, in a program before the execution of the program by a CPU (Central Processing Unit) may possibly be used. For the sake of convenience, the arithmetic represented by the code described in the program before the signature arithmetic code is embedded (that is, the original program) will be hereinafter referred to as “application arithmetic.”

Reference 1: Japanese Patent Application Laid-Open (Kokai) Publication No. H6-83663

### SUMMARY

According to the method disclosed in Reference 1, it is expected that whether there is an error in the control system or not can be checked by regularly comparing a signature value with an expected value.

However, if the method disclosed in Reference 1 is applied to the GPU, there is fear of throughput degradation. This is because: the GPU includes a plurality of arithmetic groups (commonly called an SM [Streaming Multiprocessor]) and each arithmetic group includes a plurality of cores and a control system (typically, a scheduler) for assigning commands to the plurality of cores; and if the method disclosed in Reference 1 is applied to the GPU having such a configuration, the signature arithmetic will be assigned to all the cores of the plurality of arithmetic groups.

This kind of problem may also happen with parallel arithmetic devices other than the GPU.

A program for causing a parallel arithmetic device including a plurality of arithmetic groups to execute parallel arithmetic of predetermined processing is input. The program includes information defining each of the following: application arithmetic which is a plurality of arithmetic operations constituting the predetermined processing; redundant arithmetic (which is redundant arithmetic of the application arithmetic and is arithmetic assigned to a surplus core(s) in a first arithmetic group); and diagnostic arithmetic (arithmetic that is a comparison of redundant arithmetic results of the same redundant arithmetic by two or more surplus cores which are possessed by each of two or more first arithmetic groups and that is assigned to surplus cores in a second arithmetic group). The surplus core(s) is a core to which the application arithmetic is not assigned. According to one embodiment, a program generation apparatus for generating such a program is structured.

According to the present invention, it is possible to generate the program which does not induce the redundancy of the hardware resources of the parallel arithmetic device, and suppresses the throughput degradation and detects errors in the control system.

### BRIEF DESCRIPTION OF THE DRAWINGS

FIG. 1 is an example configuration for a program generation apparatus according to a first embodiment;

FIG. 2 illustrates an example of an overview of a parallel arithmetic according to a second parallel arithmetic program;

FIG. 3 illustrates an example of a processing flow executed by the program generation apparatus according to the first embodiment;

FIG. 4 is an example configuration for a program generation apparatus according to a second embodiment;

FIG. 5 illustrates an example of a processing flow executed by the program generation apparatus according to the second embodiment;

FIG. 6 is an example configuration for a parallel arithmetic device according to a third embodiment;

FIG. 7 illustrates an example of a processing flow executed by the parallel arithmetic device according to the third embodiment;

FIG. 8 is an example configuration for a parallel arithmetic device according to a fourth embodiment;

FIG. 9 illustrates an example of a processing flow executed by the parallel arithmetic device according to the fourth embodiment;

FIG. 10 illustrates an example of processing executed by the parallel arithmetic device according to the fourth embodiment; and

FIG. 11 illustrates an example configuration for a second parallel arithmetic program.

### DESCRIPTION OF EMBODIMENTS

In the following explanation, an “interface apparatus” may be one or more interface devices. The one or more interface devices may be at least one of the following:

One or more I/O (Input/Output) interface devices. The I/O (Input/Output) interface device is an interface device for at least one of an I/O device and a remote display computer. The I/O interface device for the display computer may be a communication interface device. At least one I/O device may be a user interface device, for example, either one of input devices such as a keyboard and a pointing device, and output devices such as a display device.

One or more communication interface devices. The one or more communication interface devices may be one or more communication interface devices of the same type (for example, one or more NICs [Network Interface Cards]) or two or more communication interface devices of different types (for example, an NIC and an HBA [Host Bus Adapter]).

Furthermore, in the following explanation, a “memory” is one or more memory devices, which are an example of one or more storage devices, and may typically be a main storage device. At least one memory device in the memory may be a volatile memory device or a nonvolatile memory device.

Furthermore, in the following explanation, a “persistent storage apparatus” may be one or more persistent storage devices which are an example of one or more storage devices. The persistent storage device may typically be a nonvolatile storage device (such as an auxiliary storage device) and may specifically be, for example, an HDD (Hard Disk Drive), SSD (Solid State Drive), NVME (Non-Volatile Memory Express) drive, or SCM (Storage Class Memory).

Furthermore, in the following explanation, a “storage apparatus” may be a memory and at least a memory for the persistent storage apparatus.

Furthermore, in the following explanation, a “processor” may be one or more processor devices. At least one processor device may typically be a microprocessor device such as a CPU (Central Processing Unit). At least one processor device may be single-core or multi-core.

Furthermore, in the following explanation, a function(s) will be sometimes explained by using the expression “yyy unit”; however, the function(s) may be implemented by execution of one or more computer programs by a processor, may be implemented by one or more hardware circuits (such as FPGA or ASIC), or may be implemented by a combination of the execution of one or more computer programs by the processor and the one or more hardware circuits. If the function is implemented by the execution of the program(s) by the processor, predetermined processing is executed by using, for example, a storage apparatus and/or an interface apparatus as appropriate; and, therefore, the function may be recognized as at least part of the processor. The processing explained by referring to the function as a subject may be processing executed by the processor or an apparatus having that processor. The program(s) may be installed from a program source. The program source may be, for example, a program distribution computer or a computer-readable recording medium (such as a non-transitory recording medium). The explanation about each function is an example; and a plurality of functions may be integrated into one function or one function may be divided into a plurality of functions.

Moreover, in the following explanation, an ID is adopted as “identification information” of each element; however, other type of information (such as a name) may be adopted instead of or in addition to the ID.

Furthermore, when elements of the same type are explained without distinguishing one from another in the following explanation, a common reference numeral in reference numerals is used; and when the elements of the same type are distinguished one from another, the reference numerals may sometimes be used.

Some embodiments will be explained below.

### First Embodiment

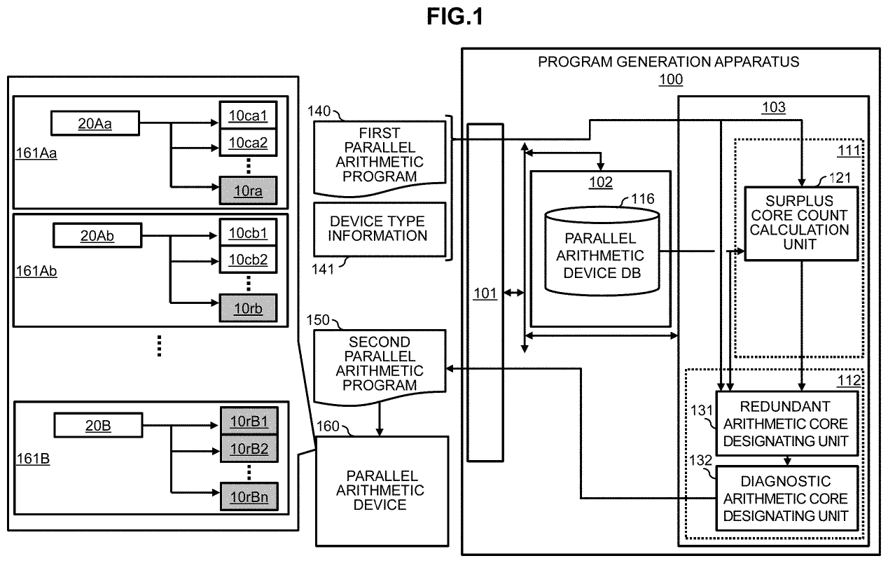

FIG. 1 illustrates an example configuration for a program generation apparatus according to a first embodiment.

A program generation apparatus 100 is an apparatus that generates a parallel arithmetic program, which is a computer program that causes a parallel arithmetic device 160 to execute predetermined processing using parallel arithmetic. The parallel arithmetic device 160 includes a plurality of arithmetic groups 161. Each arithmetic group 161 includes a plurality of cores 10 and a control system 20 that assigns the same arithmetic command to the plurality of cores 10. Incidentally, in this embodiment, “the same arithmetic command” is the equivalent of a command with the same calculation formula. Furthermore, in this embodiment, even if the calculation formula is the same, if the variable values used are different, the arithmetic (the arithmetic operation) will be different. In other words, a plurality of arithmetic operations executed using the same calculation formula and a plurality of different variable values are different arithmetic operations.

The program generation apparatus 100 may be a group of physical computers (one or more physical computers), or a logical device implemented on a group of physical computers (for example, a cloud infrastructure). The group of physical computers is equipped with, as physical or logical computing resources, an interface apparatus 101, a storage device 102, and a processor 103 connected to them. The program generation apparatus 100 includes a surplus core specifying unit 111 and a program generation unit 112.

A first parallel arithmetic program 140 and device type information 141 are input into the program generation apparatus 100 via the interface apparatus 101. The first parallel arithmetic program 140 is a computer program that defines the application arithmetic constituting predetermined processing and causes the parallel arithmetic device 160 (for example, a GPU) to execute the parallel arithmetic in the predetermined processing. The device type information 141 includes information that indicates the type (for example, device name and/or model number) of the parallel arithmetic device 160.

A second parallel arithmetic program 150 is output from the program generation apparatus 100 via the interface apparatus 101. The second parallel arithmetic program 150 is a computer program generated by the program generation apparatus 100 on the basis of the first parallel arithmetic program 140. Specifically, the second parallel arithmetic program 150 is a computer program that causes the parallel arithmetic device 160 to execute, in addition to the predetermined processing indicated by the first parallel arithmetic program 140, detection of the presence or absence of errors in the control system 20 (typically a scheduler) of the parallel arithmetic device 160.

The storage device 102 stores a group of computer programs (one or more computer programs) that are executed by the processor 103, and information that is referenced or updated by the processor 103. The information is, for example, a parallel arithmetic device DB (database) 116. The parallel arithmetic device DB 116 contains, for each device type of parallel arithmetic device, device configuration information that indicates the configuration of the parallel arithmetic device. For each device type of parallel arithmetic device, the configuration information includes at least item (a) out of items (a) to (d) below.

(a) The total core count in the parallel arithmetic device. (“core count” is the number of cores.)

(b) The number of arithmetic groups 161.

(c) Group configuration information, which is configuration information for each arithmetic group 161. For each arithmetic group 161, the group configuration information is at least one of the ID of the relevant arithmetic group 161 and the ID of each core 10 in the relevant arithmetic group 161.

(d) The address range of the storage area of the parallel arithmetic device.

The surplus core specifying unit 111 and the program generation unit 112 are implemented by the processor 103 executing a set of computer programs that are in the storage device 102. The surplus core specifying unit 111 specifies, on the basis of the first parallel arithmetic program 140, the surplus core count in the parallel arithmetic. The program generation unit 112 generates the second parallel arithmetic program 150 on the basis of the first parallel arithmetic program 140.

The surplus core specifying unit 111 includes a surplus core count calculation unit 121. The surplus core count calculation unit 121 obtains device configuration information from the parallel arithmetic device DB 116 using the input device type information as a key, and specifies the total core count indicated by the device configuration information. Furthermore, the surplus core count calculation unit 121 calculates a used core count, which is the total number of used cores 10c, on the basis of the first parallel arithmetic program 140 (specifically, for example, a source code of the first parallel arithmetic program 140). A “used core” is a core to which the application arithmetic is assigned. The surplus core count calculation unit 121 calculates the surplus core count by subtracting the used core count from the total core count. The surplus core count is the total number of surplus cores 10r. A “surplus core” is a core to which no application arithmetic is assigned (for example, a core that is in an idle state).

The program generation unit 112 includes a redundant arithmetic core designating unit 131 and a diagnostic arithmetic core designating unit 132.

Based on the calculated surplus core count, the first parallel arithmetic program 140, and the obtained device configuration information, the redundant arithmetic core designating unit 131 executes, for example, the following.

Specifically speaking, the redundant arithmetic core designating unit 131 determines two or more first arithmetic groups 161A and one or more second arithmetic groups 161B from the plurality of arithmetic groups 161 on the basis of the device configuration information. The first arithmetic group 161A is an arithmetic group that is subject to diagnosis, including for the presence or absence of errors in the control system 20. The second arithmetic group 161B is an arithmetic group that diagnoses, with respect to each first arithmetic group 161A, whether or not there is an error in the control system 20A of the first arithmetic group 161A.

Moreover, the redundant arithmetic core designating unit 131 determines a surplus core(s) 10r for each first arithmetic group 161A on the basis of the device configuration information. In other words, each first arithmetic group 161A will have at least one surplus core 10r. Incidentally, for the second arithmetic group 161B, all cores 10 are surplus cores 10r.

The redundant arithmetic core designating unit 131 also generates information defining redundant arithmetic on the basis of the first parallel arithmetic program 140. The “redundant arithmetic” is the redundant arithmetic of the application arithmetic defined by the first parallel arithmetic program 140. Specific examples of the redundant arithmetic will be explained later.

The redundant arithmetic core designating unit 131 also assigns the redundant arithmetic to the surplus core(s) 10r of the first arithmetic group 161A and determines the storage location (storage location in the storage area possessed by the parallel arithmetic device 160) for storing the results of the redundant arithmetic.

In addition, the redundant arithmetic core designating unit 131 sets information defining the redundant arithmetic. A “program undergoing editing” can be a program that the first parallel arithmetic program 140 has and that contains information that defines the application arithmetic, and corresponds to a program on the way to the second parallel arithmetic program 150. The “information defining redundant arithmetic” may include information indicating the storage location (for example, memory address) of the result of the redundant arithmetic. The “information defining redundant arithmetic” may also include the ID of the core to which the redundant arithmetic is assigned. In addition, the redundant arithmetic core designating unit 131 may set information in the program undergoing editing that indicates at least one of: which arithmetic group 161 is the first arithmetic group 161A and which arithmetic group 161 is the second arithmetic group 161B, and may also set information in the program undergoing editing that indicates at least one of: the number of first arithmetic groups 161A and the number of second arithmetic groups 161B. Moreover, the redundant arithmetic core designating unit 131 may also set information in the program undergoing editing indicating at least one of: the surplus core count and the used core count.

The diagnostic arithmetic core designating unit 132 generates information defining diagnostic arithmetic on the basis of the information output from the redundant arithmetic core designating unit 131, and sets the information in the program undergoing editing. Under this circumstance, the “information output from the redundant arithmetic core designating unit 131” includes the program undergoing editing or the information it has. Furthermore, the “diagnostic arithmetic” is a comparison of the results of the execution of the same redundant arithmetic by two or more surplus cores in each of two or more first arithmetic groups, and is arithmetic assigned to the surplus cores in the second arithmetic group. The “information defining diagnostic arithmetic” may include information indicating the storage location of the results of the diagnostic arithmetic. The “information defining diagnostic arithmetic” may also include the ID of the core to which the diagnostic arithmetic is assigned.

The program undergoing editing, in which the redundant arithmetic and diagnostic arithmetic are defined, corresponds to the generated second parallel arithmetic program 150. The second parallel arithmetic program 150 is output via the interface apparatus 101.

According to the foregoing description, the second parallel arithmetic program 150 has, in addition to the information defining the application arithmetic defined in the first parallel arithmetic program 140, information defining redundant arithmetic and information defining diagnostic arithmetic. Under this circumstance, with respect to each of the application arithmetic, redundant arithmetic, and diagnostic arithmetic, whether the arithmetic is the same or different may depend on, for example, whether the function used in the arithmetic itself is the same or different, or whether the function itself is the same but variable values are the same or different. For example, application arithmetic with the same function but different variable value ranges can be different application arithmetic.

Furthermore, the second parallel arithmetic program 150 may include information representing at least one of the following (A) through (E). This enables detailed specification for the parallel arithmetic device 160 in the execution of the second parallel arithmetic program 150.

(A) At least one of: which arithmetic group is the first arithmetic group and the number of first arithmetic groups.

(B) At least one of: which arithmetic group is the second arithmetic group and the number of second arithmetic groups.

(C) At least one of the following (c1) and (c2) with respect to redundant arithmetic.

(c1) The surplus cores to which the redundant arithmetic is assigned.

(c2) The storage location of the results of the redundant arithmetic in the parallel arithmetic device.

(D) At least one of the following (d1) and (d2) with respect to diagnostic arithmetic.

(d1) The surplus cores to which the diagnostic arithmetic is assigned.

(d2) The storage location of the results of the diagnostic arithmetic in the parallel arithmetic device.

(E) At least one of the surplus core count and the used core count.

The second parallel arithmetic program 150 is executed by the parallel arithmetic device 160 to realize the following, as is illustrated by FIG. 1. Incidentally, in the following, which arithmetic group 161 is the first arithmetic group 161A and which arithmetic group 161 is the second arithmetic group 161 B may be designated in the second parallel arithmetic program 150 or may be determined by the parallel arithmetic device 160. Furthermore, which cores 10 are the used cores 10c and which cores are the surplus cores 10r may be designated in the second parallel arithmetic program 150, or may be determined by the parallel arithmetic device 160.

Each of the two or more arithmetic groups 161 in the plurality of arithmetic groups 161 is a first arithmetic group 161A, and one arithmetic group 161 is a second arithmetic group 161B.

For each of the two or more first arithmetic groups 161Aa and 161Ab, one (or a plurality of) core(s) 10 is a surplus core(s) 10r, and the cores 10 other than the surplus core(s) 10r are used cores 10c.

In the second arithmetic group 161B, all cores 10 are surplus cores 10r.

The number of second arithmetic groups 161B depends on the number of first arithmetic groups 161A. Typically, there are fewer second arithmetic groups 161B than first arithmetic groups 161A.

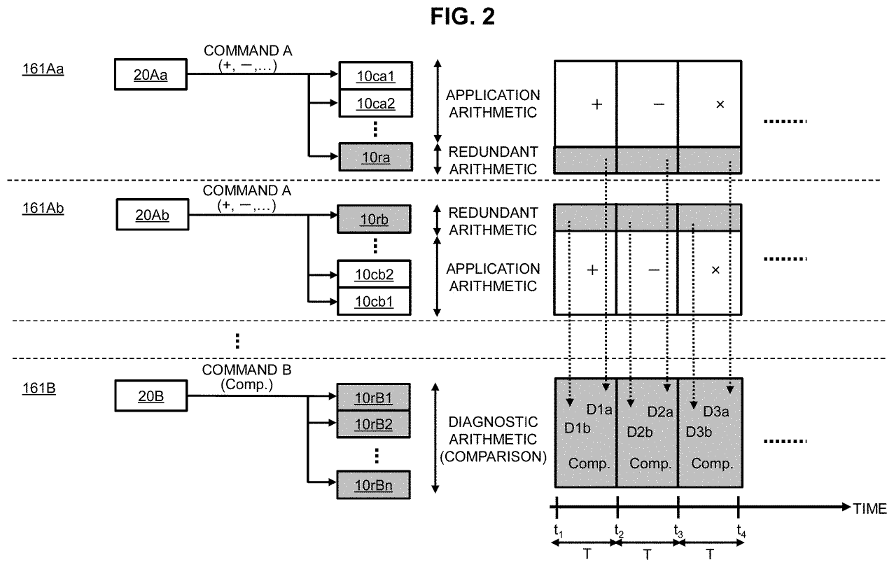

FIG. 2 illustrates an example of an overview of parallel arithmetic according to the second parallel arithmetic program 150.

In accordance with the second parallel arithmetic program 150, a command A is assigned to two or more first arithmetic groups 161Aa, 161Ab, and so on, and the command A is cached in each of the two or more first arithmetic groups 161Aa, 161Ab, and so on. The command A is a command for application arithmetic and its redundant arithmetic. In each first arithmetic group 161A, the control system 20A assigns the cached command A to a plurality of cores in the first arithmetic group 161A. Specifically, the application arithmetic that follows the command A is assigned to the used cores 10c, and the redundant arithmetic that follows the command A is assigned to the surplus cores 10r.

In accordance with the second parallel arithmetic program 150, a command B is assigned to the second arithmetic group 161B, and the command B is cached in the second arithmetic group 161B. The command B is a diagnostic arithmetic command. In the second arithmetic group 161B, the control system 20B assigns the cached command B to all surplus cores 10rB in the second arithmetic group 161B.

By having the command A assigned to each first arithmetic group 161A and the command B assigned to the second arithmetic group 161B, for example, for every fixed time T, application arithmetic, redundant arithmetic and diagnostic arithmetic are executed in parallel in the parallel arithmetic device 160.

Specifically, for example, at a time-of-day interval (time interval) t₁-t₂, two or more first arithmetic groups 161Aa, 161Ab, and so on respectively execute application arithmetic and its redundant arithmetic, and store the application arithmetic results and the redundant arithmetic results D1a, D1b, and so on for example, in storage areas that are respectively defined in the second parallel arithmetic program 150. Then, the second arithmetic group 161B reads the redundant arithmetic results D1a, D1b, and so on from the storage areas and executes diagnostic arithmetic, which is a comparison of the read redundant arithmetic results D1a, D1b, and so on (for example, the surplus core 10rB1 compares D1a with D1b). If the redundant arithmetic results D1a, D1b, and so on are all the same, the diagnostic arithmetic result is the result that there is no error in any of the control systems 20A. If at least one surplus core 10rB detects a discrepancy in the redundant arithmetic result, it outputs the result that there is an error. From this result, it can be assumed that there is an error in the control system 20A in the arithmetic group 161A that includes the surplus core 10r that produced the redundant arithmetic result including the discrepancy. If any of the control systems 20A has an error, the command A assigned from the control system 20A will have an error, and as a result, the result of the redundant arithmetic following the command A from the control system 20A will not match the result of the redundant arithmetic following the command A from a normal control system 20A. It is possible for a system external to the parallel arithmetic device 160 (for example, a host system) to identify which of the redundant arithmetic results output from the two or more first arithmetic groups 161A had the discrepancy, for example, from information output by the surplus core 10rB that detected the discrepancy in the redundant arithmetic results (for example, information containing the ID of the first arithmetic group 161 that output the redundant arithmetic results).

The same processing is executed thereafter. In other words, the following (X) and (Y) are executed in parallel during the time-of-day interval tₙ-t₍ₙ₊₁₎ (where n is a natural number). At least a part of the information that defines the arithmetic is implemented as a kernel in the parallel arithmetic device 160, and the arithmetic indicated by that information is executed in the parallel arithmetic device 160.

(X) Each first arithmetic group 161A executes the application arithmetic and the redundant arithmetic, and stores the application arithmetic result and the redundant arithmetic results Dna, Dnb, and so on in a storage area.

(Y) The second arithmetic group 161B reads the stored redundant arithmetic results Dna, Dnb, and so on, executes diagnostic arithmetic, which is a comparison of them, and stores the diagnostic arithmetic results in the storage area.

In this embodiment, the arithmetic group 161 and its role (whether it is the target of diagnosis or executes diagnosis) are fixed regardless of the value of n in the time-of-day interval tₙ-t₍ₙ₊₁₎, but the arithmetic group 161 and its role may also change depending on the value of n. For example, there may be an arithmetic group 161 that switches from the first arithmetic group 161A to the second arithmetic group 161B on a regular or irregular basis, and an arithmetic group 161 that switches from the second arithmetic group 161B to the first arithmetic group 161A on a regular or irregular basis. Information indicating the change in the role of the arithmetic group 161 and the timing thereof may be described in the second parallel arithmetic program 150, and based on that information, the change in the role of the arithmetic group 161 may be performed in the parallel arithmetic device 160. Incidentally, the number of first arithmetic groups 161A and the number of second arithmetic groups 161B may be maintained even if the role change takes place.

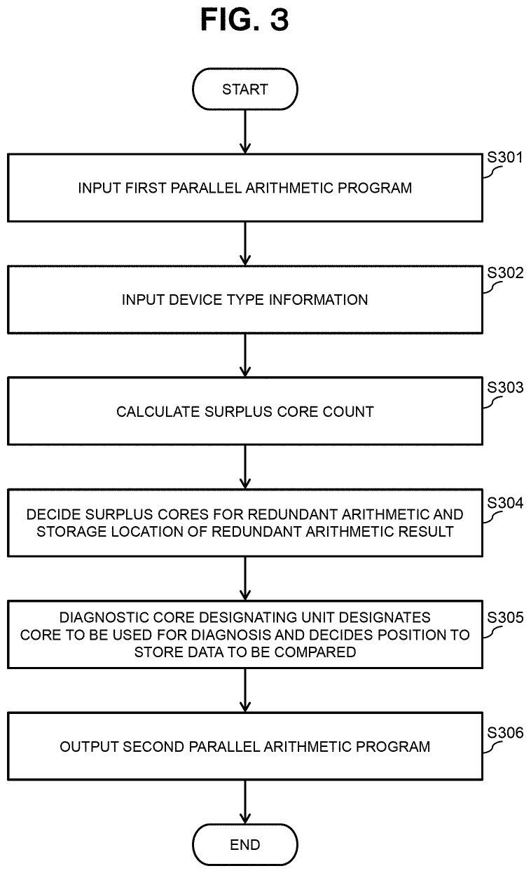

FIG. 3 illustrates an example of the processing flow executed by the program generation apparatus 100.

The first parallel arithmetic program 140 is input into the surplus core specifying unit 111 and the program generation unit 112 from a first input source (S301). The first input source can be an external storage device or a user terminal, etc.

Device type information 141 is input into the surplus core specifying unit 111 from the first input source or a second input source (S302). The second input source may be, for example, a command or GUI (Graphical User Interface).

The surplus core count calculation unit 121 in the surplus core specifying unit 111 calculates the surplus core count (S303). Specifically, the surplus core count calculation unit 121 obtains device configuration information from the parallel arithmetic device DB116 using the device type information 141 entered in S302 as a key. Instead of the input of the device type information 141 and the existence of the parallel arithmetic device DB116, the device configuration information itself may be input, for example, from the first input source or the second input source. The surplus core count calculation unit 121 identifies the total core count indicated by the acquired device configuration information. Furthermore, the surplus core count calculation unit 121 specifies the used core count on the basis of the first parallel arithmetic program 140 input in S301. The surplus core count calculation unit 121 calculates the surplus core count by subtracting the used core count from the total core count. Specifically, for example, the surplus core count calculation unit 121 specifies the number of threads (for example, one thread corresponds to one core) and the number of blocks (bundles of threads) on the basis of the first parallel arithmetic program 140, and specifies the used core count on the basis of the number of threads and the number of blocks. For example, if the number of blocks is 1, and the number of threads that constitute a block is 700, when the number of blocks is 1, the used core count is 700 (=1×700). Moreover, for example, if the number of threads that constitute a block is 200 and the number of blocks is 5, the used core count is 1000 (=5×200). The surplus core count calculation unit 121 calculates the surplus core count by subtracting such used core count from the total core count.

The redundant arithmetic core designating unit 131 in the program generation unit 112 determines the redundant arithmetic, the core(s) to which the redundant arithmetic is assigned (surplus core(s) for redundant arithmetic), and the storage location for the redundant arithmetic results on the basis of the first parallel arithmetic program 140 input in S301, the surplus core count calculated in S303, and the device configuration information obtained in S302, and sets the information indicating these determined details in the program undergoing editing (S304).

Based on the details determined in S304 and the device configuration information obtained in S302, the diagnostic arithmetic core designating unit 132 in the program generation unit 112 determines the diagnostic arithmetic, the core(s) to which the diagnostic arithmetic is assigned (surplus core(s) for diagnostic arithmetic), and the storage location for the results of the diagnostic arithmetic, and the information indicating those determined details is set in the program undergoing editing (S305). This causes the program undergoing editing to become the second parallel arithmetic program 150, or in other words, the second parallel arithmetic program 150 is generated.

The diagnostic arithmetic core designating unit 132 outputs the generated second parallel arithmetic program 150 (S306).

In this way, according to the first embodiment, a plurality of surplus cores 10r to which the application arithmetic defined in the first parallel arithmetic program 140 is not assigned is specified, the redundant arithmetic in the application arithmetic is assigned to the surplus cores 10r in the first arithmetic group 161A (diagnosis target arithmetic group), and the diagnostic arithmetic is assigned to the surplus cores 10r in the second arithmetic group 161B (arithmetic group for diagnosis). The surplus cores 10r of each first arithmetic group 161A execute the redundant arithmetic, and the surplus cores 10r of the second arithmetic group 161B execute the diagnostic arithmetic, which is a comparison of the redundant arithmetic results. If there is a discrepancy in a redundant arithmetic result, it can be detected that there is an error in the control system 20A in the first arithmetic group 161A that includes the surplus core 10r that produced the redundant arithmetic result. In this way, it is possible to automatically generate a program that detects errors in the control system 20A without causing redundancy in the hardware resources of the parallel arithmetic device 160 and while suppressing any throughput degradation.

Moreover, according to the first embodiment, the total core count in the parallel arithmetic device 160 is specified, the used core count is specified on the basis of the first parallel arithmetic program 140, and the difference between them is calculated as the surplus core count. This enables accurate specification of the number of surplus cores that will be generated in the parallel arithmetic device 160 that executes the first parallel arithmetic program 140.

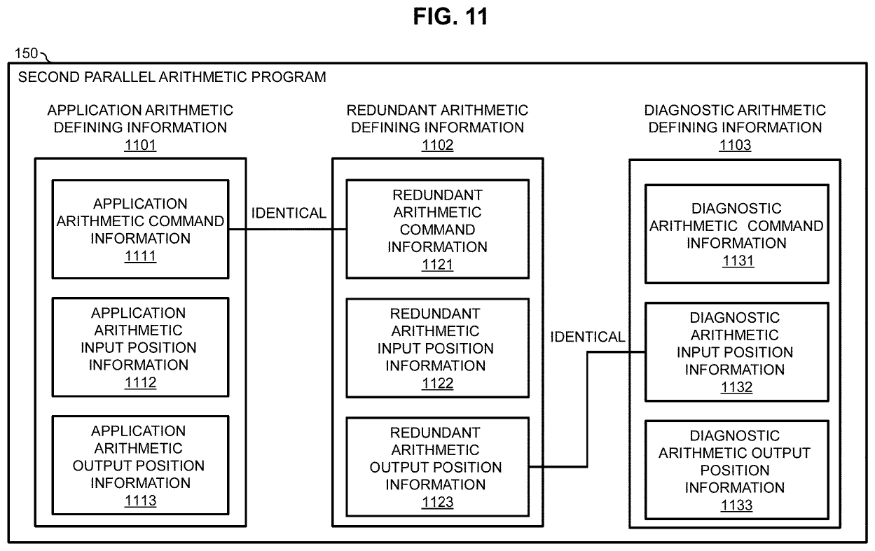

The configuration of the second parallel arithmetic program 150 may be the configuration illustrated in FIG. 11. In other words, the configuration described below may be adopted.

The second parallel arithmetic program 150 includes application arithmetic defining information 1101, redundant arithmetic defining information 1102, and diagnostic arithmetic defining information 1103.

The application arithmetic defining information 1101 is information that defines the application arithmetic. For example, the application arithmetic defining information 1101 includes application arithmetic command information 1111 (for example, information containing the calculation formula and variable value range for the application arithmetic) indicating a command for application arithmetic, application arithmetic input position information 1112 indicating a location (for example, address of a storage area) where the information used in the application arithmetic (for example, variable values for the calculation formula) is input, and application arithmetic output position information 1113 indicating the output destination (storage location) of the results of the application arithmetic. For example, the used cores 10c to which the application arithmetic is assigned read the values from the location indicated by the information 1112, execute the application arithmetic according to the information 1111 using the values as input, and output the results of the application arithmetic to the output destination indicated by the information 1113.

The redundant arithmetic defining information 1102 is information that defines redundant arithmetic. For example, the redundant arithmetic defining information 1102 includes redundant arithmetic command information 1121 (for example, information containing the calculation formula and variable value range for the redundant arithmetic) indicating a command for redundant arithmetic, redundant arithmetic input position information 1122 indicating a location where the information used in the redundant arithmetic (for example, variable values for the calculation formula) is input, and redundant arithmetic output position information 1123 indicating the output destination of the results of the redundant arithmetic. For example, the surplus cores 10r to which the redundant arithmetic is assigned read the values from the location indicated by the information 1122, execute the redundant arithmetic according to the information 1121 using the values as input, and output the results of the redundant arithmetic to the output destination indicated by the information 1123.

The diagnostic arithmetic defining information 1103 is information that defines diagnostic arithmetic. For example, the diagnostic arithmetic defining information 1103 includes diagnostic arithmetic command information 1131 (for example, information containing the calculation formula and variable value range for the diagnostic arithmetic) indicating a command for diagnostic arithmetic, diagnostic arithmetic input position information 1132 indicating a location where the information used in the diagnostic arithmetic (the results of the redundant arithmetic) is input, and diagnostic arithmetic output position information 1133 indicating the output destination of the results of the diagnostic arithmetic. For example, the surplus cores 10rB to which the diagnostic arithmetic is assigned read the values from the location indicated by the information 1132, execute the diagnostic arithmetic according to the information 1131 using the values as input, and output the results of the diagnostic arithmetic to the output destination indicated by the information 1133.

The information 1101 may be referred to as an application arithmetic code, the information 1102 as a redundant arithmetic code, and the information 1103 as a diagnostic arithmetic code. At least one of the application arithmetic code, the redundant arithmetic code, and the diagnostic arithmetic code may exist in plurality.

The configuration illustrated in FIG. 11 can be a conceptual configuration, and in practice, some parts may overlap.

For example, at least part of the application arithmetic command information 1111 (for example, information indicating the calculation formula) and at least part of the redundant arithmetic command information 1121 may overlap. Specifically, for example, let us assume that a single application arithmetic code in the first parallel arithmetic program 140 describes the formula y=a*x+b, that a first arithmetic group 160Aa is responsible for 0≤x≤31, and that a first arithmetic group 160Ab is responsible for 32≤x≤63. The program generation unit 112 defines redundant arithmetic by adjusting the x-range (variable value range) of each first arithmetic group 160A so that a portion of the x-range overlaps with a portion of the x-range of the other first operation groups 160A. For example, by changing the x range of a first arithmetic group 160Ab to 30≤x≤61, the program generation unit 112 defines redundant arithmetic (the calculation formula is y=a*x+b, which is the same as that of the application arithmetic) in which x=30, 31 overlaps with the x range of the first calculation group 160Aa (0≤x≤31). Accordingly, part of the application arithmetic code has been changed to the code that performs application arithmetic and redundant arithmetic (where the x range is 30≤x≤31). In other words, at least part of the application arithmetic code can become inseparable from at least part of the redundant arithmetic code. Therefore, a combination code of the application arithmetic code and the redundant arithmetic code may exist. A code like this is an example of the code that defines application arithmetic and redundant arithmetic.

Furthermore, for example, in the diagnostic arithmetic, the information 1123 and information 1132 can be the same information because the redundant arithmetic results are read from the output destination of the redundant arithmetic results.

### Second Embodiment

An explanation will be provided about a second embodiment. In doing so, the explanation will mainly be regarding the differences from the first embodiment, and any common points with the first embodiment will be omitted or simplified.

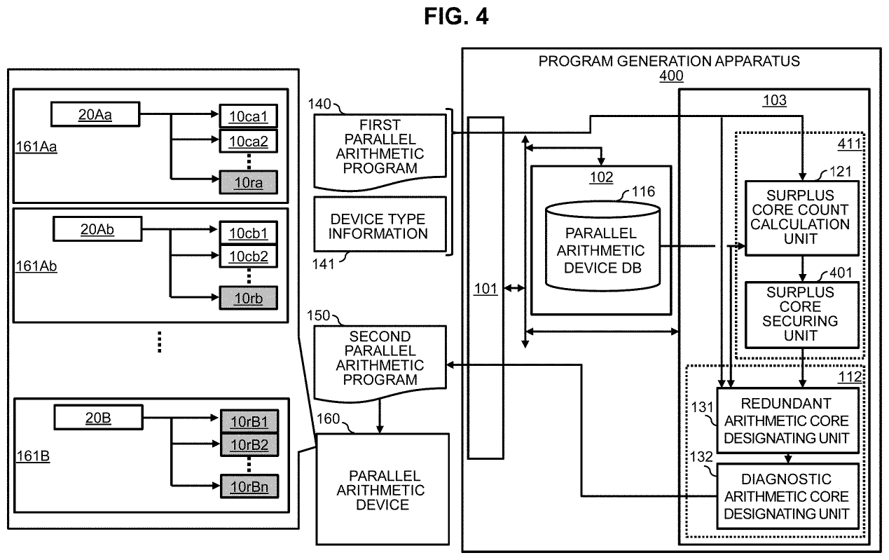

FIG. 4 illustrates an example configuration for a program generation apparatus according to a second embodiment.

In a program generation apparatus 400, a surplus core specifying unit 411 includes a surplus core count calculation unit 121 and a surplus core securing unit 401. When the calculated surplus core count is a number that implies a shortage of surplus cores (in other words, when the calculated surplus core count is less than the required surplus core count), the surplus core securing unit 401 secures the number of surplus cores required for the surplus core count (or more).

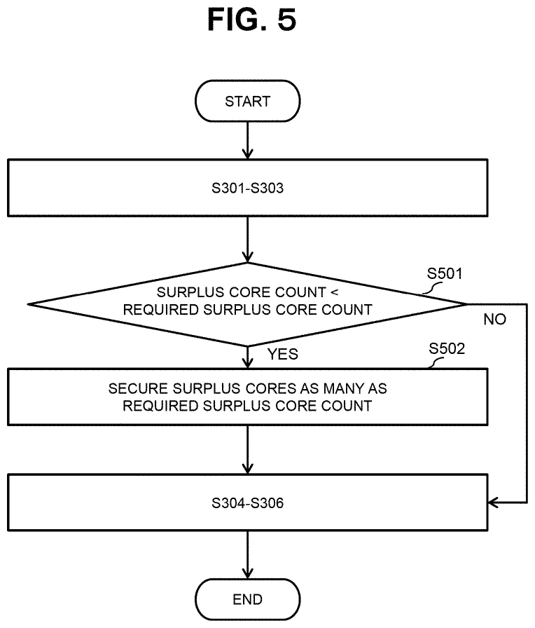

FIG. 5 illustrates an example of the processing flow executed by the program generation apparatus 100.

After S301 to S303 (see FIG. 3), the surplus core securing unit 401 specifies the required surplus core count on the basis of the first parallel arithmetic program 140 (for example, specifies the required surplus core count from the information defining the application arithmetic which is described in the first parallel arithmetic program 140 and on the basis of the number of the redundant arithmetic operations which are estimated to be necessary), and makes a shortage judgment, which is a judgment of whether the surplus core count calculated in S303 is less than the specified required surplus core count (S501). If the result of the shortage judgment is false (S501: NO), S304 to S306 (see FIG. 3) are performed on the basis of the calculated surplus core count.

If the result of the shortage judgment is true (for example, if the calculated surplus core count is 0) (S501: YES), the surplus core securing unit 401 secures the required surplus core count number of surplus cores by setting some of the used cores from the plurality of used cores in the used core count specified on the basis of the first parallel arithmetic program 140 as surplus cores (S502). Based on the number of surplus cores secured, or in other words, the required surplus core count, S304 to S306 (see FIG. 3) are performed.

According to the second embodiment, even when there is a shortage of surplus cores, the redundant arithmetic and the diagnostic arithmetic can be executed in parallel with the application arithmetic by using the required surplus core count number of surplus cores.

### Third Embodiment

An explanation will be provided about a third embodiment. The third embodiment relates to a parallel arithmetic device 160 that executes the second parallel arithmetic program 150 generated by the program generation apparatus 100 of the first embodiment or the program generation apparatus 400 of the second embodiment.

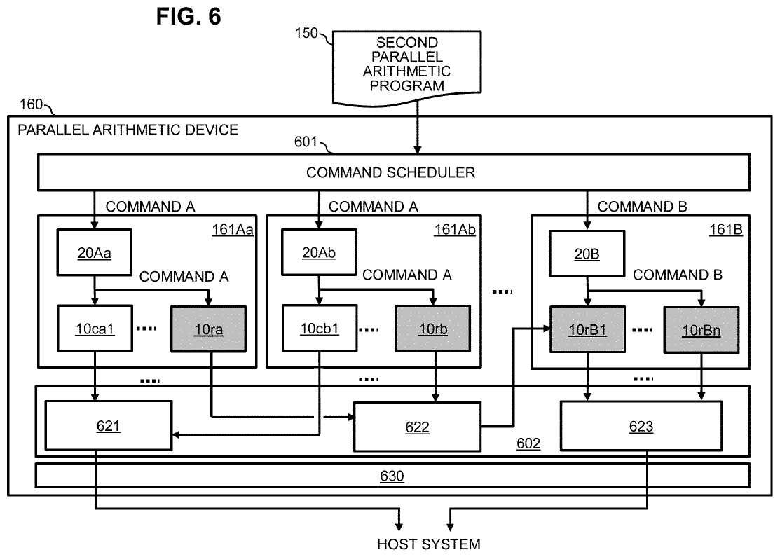

FIG. 6 illustrates an example configuration for a parallel arithmetic device 160 according to a third embodiment.

The parallel arithmetic device 160 has, in addition to a plurality of arithmetic groups 161, a command assignment unit 601 and a storage area 602 (for example, a memory).

The command assignment unit 601 assigns commands to a plurality of arithmetic groups 161 on the basis of the information described in the second parallel arithmetic program 150 input into the parallel arithmetic device 160 (for example, information defining arithmetic such as application arithmetic, redundant arithmetic, and diagnostic arithmetic).

The storage area 602 includes an application arithmetic result area 621, which is the area where application arithmetic results are stored, a redundant arithmetic result area 622, which is the area where redundant arithmetic results are stored, and a diagnostic arithmetic result area 623, which is the area where diagnostic arithmetic results are stored. The areas 621, 622, and 623 are all areas indicated by the information defined in the second parallel arithmetic program 150. Specifically, for example, the application arithmetic result area 621 is the area indicated by the information 1113 shown in FIG. 11, the redundant arithmetic result area 622 is the area indicated by the information 1123 shown in FIG. 11, and the diagnostic arithmetic result area 623 is the area indicated by the information 1133 shown in FIG. 11.

The application arithmetic results stored in the application arithmetic result area 621 are output to (for example, read out by) a host system that executes processing on the basis of the application arithmetic results. Furthermore, the diagnostic arithmetic results stored in the diagnostic arithmetic result area 623 are output to (for example, read out by) the host system. The host system, for example, is usually designed to perform automatic processing on the basis of the input (for example, read-out) application arithmetic results, and to run the processing without any data input from a user. The host system is, for example, designed to continue the automatic processing until an error in the control system 20 is detected. If the host system identifies, for example, that an error in the control system 20 has been detected from the received (for example, read-out) diagnostic arithmetic results, it will, instead of the automatic processing, run manual processing that requires data input from the user as appropriate. In this way, the host system can decide whether to change or continue any determined processing (for example, processing mode) depending on whether an error in the control system 20 has been detected from the diagnostic arithmetic results. Incidentally, the host system may be an example of at least one of the one or more external systems of the parallel arithmetic device 160. Moreover, the external system to which the application arithmetic results are output and the external system to which the diagnostic arithmetic results are output may be the same or different.

The parallel arithmetic device 160 includes an external interface 630, which is an interface to an external system such as a host system and includes the function to process data that is output to the external system. For example, the external interface 630 may analyze the data stored in the diagnostic arithmetic result area 623 and output the analysis results to the host system as diagnostic arithmetic results. Furthermore, the function as the external interface 630 may be, as exemplified in FIG. 6, implemented outside the arithmetic group 161, or alternatively or additionally, the external interface for the output of application arithmetic results may be implemented by the used cores 10c of each first arithmetic group 161A, and the external interface for the output of diagnostic arithmetic results may be implemented by the surplus cores 10r of the second arithmetic group 161B.

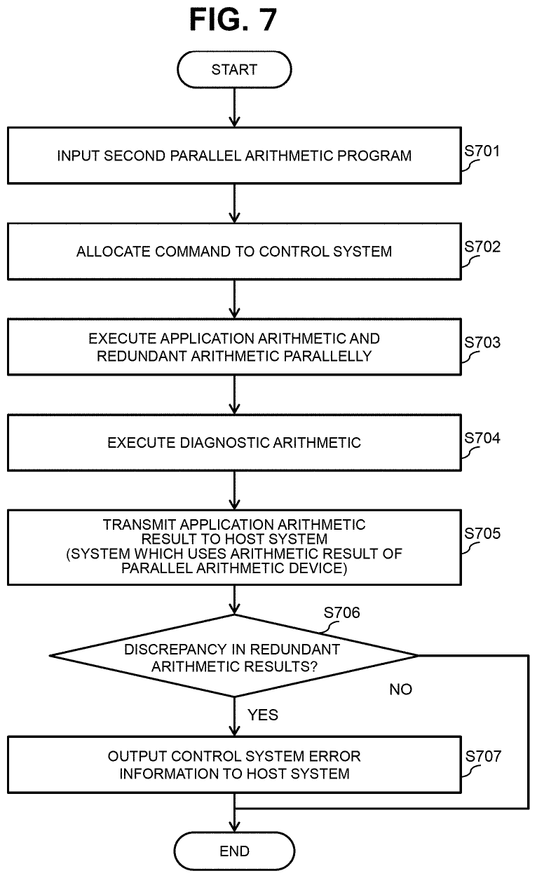

FIG. 7 illustrates an example of the processing flow executed by the parallel arithmetic device 160.

The second parallel arithmetic program 150 is input into the command assignment unit 601 (S701).

The command assignment unit 601 assigns a command to the control system 20 of each arithmetic group 161 on the basis of the second parallel arithmetic program 150 (S702). Specifically, the command assignment unit 601 assigns a command A to the first arithmetic group 161A and a command B to the second arithmetic group 161B. The commands A and B are as described above. In other words, the command A is a command for application arithmetic and its redundant arithmetic (for example, a command for arithmetic indicated by one or more application arithmetic codes and redundant arithmetic codes for each of the one or more application arithmetic codes). The command B is a command for diagnostic arithmetic (for example, a command for arithmetic indicated by one or more diagnostic arithmetic codes). In the first arithmetic group 161A, the control system 20A assigns the application arithmetic code to the used cores 10c and the redundant arithmetic code to the surplus cores 10R according to the command A. In the second arithmetic group 161B, a control system 20B assigns the diagnostic arithmetic code to the surplus cores 10r according to the command B.

The application arithmetic and the redundant arithmetic are executed in parallel, and the results of each are stored in the storage area 602 (S703). Specifically, for example, the second parallel arithmetic program 150 describes, for each of the application arithmetic and the redundant arithmetic, information indicating the storage location (in this case, the address of the storage area 602). The used cores 10c in each first arithmetic group 161A execute the assigned application arithmetic and store the application arithmetic results in the application arithmetic result area 621, which is designated as the storage location for the application arithmetic results. The surplus cores 10r in each first arithmetic group 161A execute the assigned redundant arithmetic and store the redundant arithmetic results in the redundant arithmetic result area 622, which is designated as the storage location for the redundant arithmetic results. This S703 is repeated until all the application arithmetic and redundant arithmetic according to the command A are completed.

The diagnostic arithmetic is performed in parallel with S703, and the result of the diagnostic arithmetic is stored in the storage area 602 (S704). Specifically, for example, in the second parallel arithmetic program 150, information indicating the storage location is described for the diagnostic arithmetic. The surplus cores 10r in the second arithmetic group 161B read, according to the assigned command B, the redundant arithmetic results from the redundant arithmetic result area 622, which is designated as the storage location for the redundant arithmetic results, execute the diagnostic arithmetic to compare the read redundant arithmetic results, and store the diagnostic arithmetic results in the diagnostic arithmetic result area 623, which is designated as the storage location for the diagnostic arithmetic results. This S704 is repeated until all until all comparisons of redundant arithmetic results are completed.

The application arithmetic results in the application arithmetic result area 621 are output to the host system, for example, via the external interface 630 (S705). S705 may be performed after all application arithmetic according to the command A is completed, or periodically (for example, every fixed time T [for example, every time application arithmetic is performed]).

For example, the external interface 630 judges if the result of the diagnostic arithmetic in the diagnostic arithmetic result area 623 is a result that implies a redundant arithmetic result with a discrepancy has been obtained (S706). If the result of the judgment in S706 is true (S706: YES), the external interface 630 outputs control system error information, which is information that implies there is an error in the control system 20, to the host system as the result of the diagnostic arithmetic (S707). S706 and S707 may be performed after all diagnostic arithmetic according to the command B is completed, or periodically (for example, every fixed time T [for example, every time the diagnostic arithmetic is performed]).

According to the third embodiment, the second parallel arithmetic program 150 generated in the first or second embodiment can be used to detect errors in the control system 20 of the parallel arithmetic device 160 while suppressing any increase in hardware resources or any throughput degradation.

Incidentally, the second parallel arithmetic program may be incorporated into the parallel arithmetic device 160 in advance. Furthermore, in the third embodiment, the second parallel arithmetic program 150 may be a program generated by something other than the program generation apparatus 100 or 400 (for example, by a user).

### Fourth Embodiment

An explanation will be provided about a fourth embodiment. In doing so, the explanation will mainly be regarding the differences from the third embodiment, and any common points with the third embodiment will be omitted or simplified.

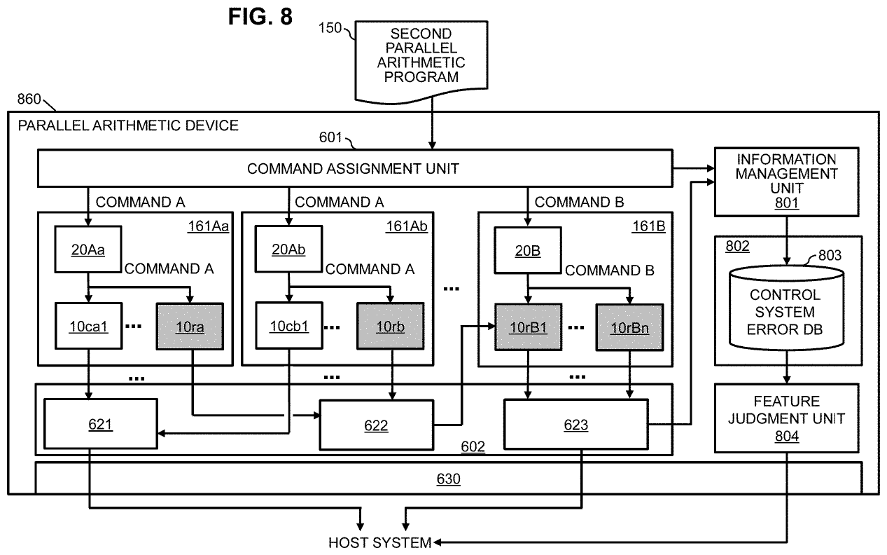

FIG. 8 illustrates an example configuration for a parallel arithmetic device according to a fourth embodiment.

A parallel arithmetic device 860 further includes an information management unit 801 and a feature judgment unit 804.

The information management unit 801 manages a control system error DB 803 (an example of error management information), which is information regarding an error result (a diagnostic arithmetic result meaning an error exists) identified from the diagnostic arithmetic result area 623. The control system error DB 803 is a database stored in a storage area 802 of the parallel arithmetic device 860. The storage area 802 is, for example, an area in a memory that is the same as or different from the storage area 602. This information management unit 801 enables judgement of device features described below for the parallel arithmetic device 860. The control system error DB 803 includes, for example, as described below, information indicating the number of errors (the number of times an error result was obtained) for each command for which an error result was obtained, and information indicating the occurrence time-of-day for each error result.

Based on the control system error DB 803, the feature judgment unit 804 judges the device features, including at least one of the characteristics and status of the parallel arithmetic device 860. For example, the external interface 630 outputs information indicating the judged device features to the host system. This allows the host system to execute processing on the basis of the device features. This embodiment employs at least one of the following as at least part of the device features: a vulnerable command(s) and an error type. The vulnerable commands and the error type will be respectively described later.

Incidentally, the external system to which the information indicating the device features is output may be the same as or different from the output destination of the application arithmetic results, or may be the same as or different from the output destination of the diagnostic arithmetic results.

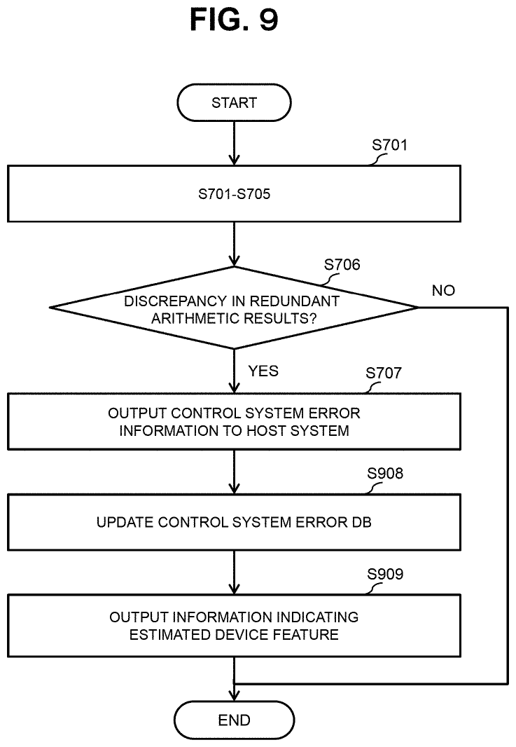

FIG. 9 illustrates an example of the processing flow executed by the parallel arithmetic device 860.

In addition to S701 to S707 in FIG. 7, if the result is YES in S706, S908 and S909 are performed. In other words, the information management unit 801 updates the control system error DB 803 (S908). Based on the control system error DB 803, the feature judgment unit 804 judges the device features of the parallel arithmetic device 860, and, for example, the external interface 630 outputs information indicating the judged device features to the host system (S909).

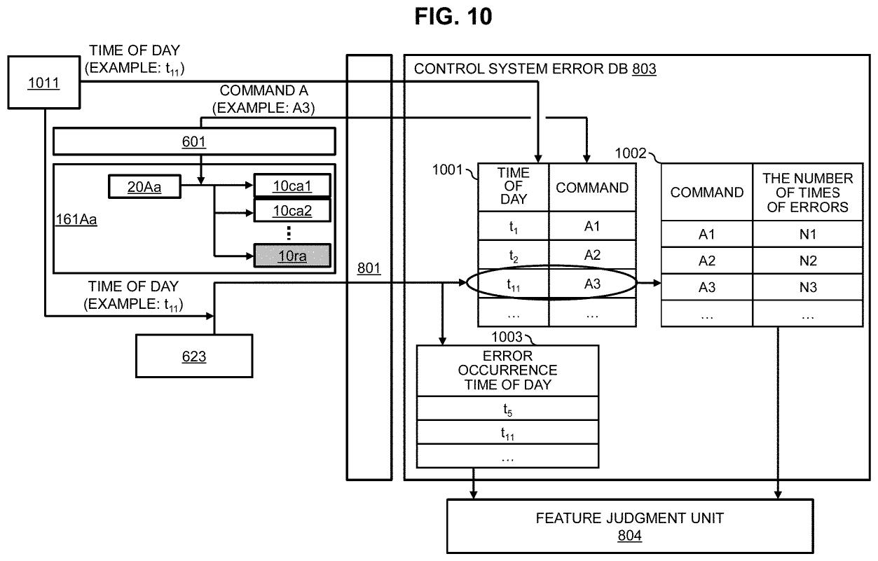

FIG. 10 illustrates an example of the processing performed by the parallel arithmetic device 860.

There is a time-of-day source 1011 inside or outside the parallel arithmetic device 860. The time-of-day source 1011 may be, for example, a GPS (Global Positioning System) sensor or timer, and outputs information indicating the time-of-day. The time-of-day source 1011, for example, regularly outputs information indicating the time-of-day.

The control system error DB 803 includes a first table 1001, a second table 1002, and a third table 1003. The first table 1001 and the second table 1002 are examples of information used to judge a vulnerable command, and the third table 1003 is an example of information used to judge an error type. The third table 1003 may exist without the first table 1001 and the second table 1002, or the first table 1001 and the second table 1002 may exist without the third table 1003.

The first table 1001 is a table that shows the correspondence between a time-of-day and a command A. The information management unit 801 may obtain the command A from the command assignment unit 601 or from the first arithmetic group 161A. In addition, instead of the command A itself, the ID of the command A may be obtained and registered in the first table 1001.

The second table 1002 is a table that shows the correspondence between the command A and the number of errors. The “number of errors” is the number of times an error result has occurred.

The third table 1003 is a table that corresponds to a list of error-occurrence times-of-day. The “error-occurrence time(s)-of-day” is the time(s)-of-day at which an error result has occurred.

For each time-of-day interval tₙ-t₍ₙ₊₁₎, if the command A is assigned to any of the first arithmetic groups 161A, the parallel arithmetic device 860 will, for example, perform the following processing within this time-of-day interval tₙ-t₍ₙ₊₁₎.

The information management unit 801 acquires the assigned command A (for example, a command A3) and a time-of-day tₙ (for example, a time-of-day t₁₁) indicated by information output by the time-of-day source 11, and adds the pair of the acquired time-of-day and the command A to the first table 1001.

The redundant arithmetic and the diagnostic arithmetic are performed for the command A at the time-of-day tₙ-t₍ₙ₊₁₎.

If an error result is stored in the diagnostic arithmetic result area 623, the information management unit 801 identifies the command A (for example, the command A3) from the first table 1001 using the time-of-day tₙ (for example, time-of-day t₁₁) as a key, and increments the number of errors corresponding to the identified command A (the number of errors registered in the second table 1002) by one. In this way, the number of errors for the command A (for example, the command A3) is updated.

If an error result is stored in the diagnostic arithmetic result area 623, the information management unit 801 registers the time-of-day tₙ as an error-occurrence time-of-day in the third table 1003.

The feature judgment unit 804, for example, regularly or irregularly refers to the second table 1002 in the control system error DB 803 and judges that the command A with the highest number of errors is a vulnerable command. The “command A with the highest number of errors” is an example of a command A with a relatively high number of errors indicated by the second table 1002. Instead of the “command A with the highest number of errors,” a command A with the number of errors in the top X % may be judged to be a vulnerable command. Furthermore, alternatively, a command A with the number of errors larger than a predetermined threshold, in other words, the command A with an absolutely high number of errors may be judged to be a vulnerable command. A “vulnerable command” is a command A that is judged to easily produce error results. The ability to judge vulnerable commands is expected to contribute to the generation of the second parallel arithmetic program 150, which improves the error tolerance of the control system 20A. For example, if a certain command A easily produces error results, it is possible to write an arithmetic code for another command A that produces the same application arithmetic results as the above-described command A.

The feature judgment unit 804, for example, regularly or irregularly refers to the third table 1003 in the control system error DB 803 and judges the error type on the basis of a trend in the error-occurrence time-of-day interval. For example, if the length of the error-occurrence time-of-day interval (the interval between the time-of-day an error occurs and the time-of-day the next error occurs) is less than a predetermined threshold, the feature judgment unit 804 judges the error type of the cause of the error result as being a temporary error. Meanwhile, if the length of the error-occurrence time-of-day interval exceeds a predetermined threshold, the feature judgment unit 804 judges the error type of the cause of the error result as being a permanent error. In this way, it is expected that the type of error in the parallel arithmetic device 860 can be efficiently identified without the use of the host system.

Although several embodiments have been explained above, they are merely examples for the purpose of explaining the invention, and are not intended to limit the scope of the invention to those embodiments alone. The present invention can be implemented in various other forms as well. For example, in the above-mentioned embodiments, in order to simplify the explanations, it is assumed that the application arithmetic, the redundant arithmetic, and the diagnostic arithmetic for the same command A are performed during the same time-of-day interval, but the time it takes from the start of the redundant arithmetic until the diagnostic arithmetic can be started for the same command A, and the time required for the diagnostic arithmetic can be estimated in advance, and then, on the basis of the various estimated times, the time-of-day associated with the command A and the time-of-day considered to be the error-occurrence time-of-day may be corrected, after which the post-correction times of day can be recorded in the control system error DB 803.

What is claimed is:

1. A program generation apparatus comprising:
a surplus core specifying unit configured to specify a surplus core count in parallel arithmetic on the basis of device configuration information representing a configuration of a parallel arithmetic device, which is a device including a plurality of arithmetic groups and capable of parallel arithmetic, and a first parallel arithmetic program for defining application arithmetic, which constitutes predetermined processing, and causing the parallel arithmetic device to execute parallel arithmetic of the predetermined processing,
wherein each of the plurality of arithmetic groups includes a plurality of cores and a control system configured to assign the same arithmetic command to the plurality of cores, and
wherein a surplus core is a core to which the application arithmetic is not assigned; and
a program generation unit configured to generate, on the basis of the first parallel arithmetic program, a second parallel arithmetic program for defining redundant arithmetic and diagnostic arithmetic as well as the application arithmetic and causing the parallel arithmetic device to execute the parallel arithmetic of the predetermined processing,
wherein the redundant arithmetic is redundant arithmetic of the application arithmetic and is arithmetic assigned to a surplus core in a first arithmetic group, and wherein the diagnostic arithmetic is a comparison of execution results of the same redundant arithmetic by two or more surplus cores possessed by each of two or more first arithmetic groups and is arithmetic assigned to a surplus core in a second arithmetic group.

2. The program generation apparatus according to claim 1,
wherein the surplus core specifying unit:
specifies a used core count of the parallel arithmetic device on the basis of the first parallel arithmetic program; and
calculates a surplus core count by subtracting the specified used core count from a total core count represented by the device configuration information;
wherein a used core is a core to which the application arithmetic is assigned; and
wherein the calculated surplus core count is the specified surplus core count.

3. The program generation apparatus according to claim 2,
wherein the surplus core specifying unit:
specifies a required surplus core count on the basis of the first parallel arithmetic program;
performs a shortage judgment to judge whether the calculated surplus core count is less than the specified required surplus core count or not; and
secures the specified required surplus core count by setting some of a plurality of used cores as many as the calculated used core count as surplus cores if a result of the shortage judgment is true; and
wherein the secured required surplus core count is the specified surplus core count.

4. The program generation apparatus according to claim 1,
wherein the second parallel arithmetic program includes information representing at least one of the following (A) through (E):
(A) at least one of: which arithmetic group is the first arithmetic group and the number of first arithmetic groups;
(B) at least one of: which arithmetic group is the second arithmetic group and the number of second arithmetic groups;
(C) at least one of the following (c1) and (c2) with respect to the redundant arithmetic;
(c1) the surplus cores to which the redundant arithmetic is assigned;
(c2) a storage location of a result of the redundant arithmetic in the parallel arithmetic device;
(D) at least one of the following (d1) and (d2) with respect to the diagnostic arithmetic;
(d1) the surplus cores to which the diagnostic arithmetic is assigned;
(d2) a storage location of a result of the diagnostic arithmetic in the parallel arithmetic device; and
(E) at least one of the surplus core count and the used core count.

5. A parallel arithmetic device which is a device capable of parallel arithmetic for executing the second parallel arithmetic program generated by the program generation apparatus as stated in claim 1,
the parallel arithmetic device comprising:
a plurality of arithmetic groups;
a command assignment unit configured to assign, in accordance with the second parallel arithmetic program, a first command which is a command for application arithmetic and redundant arithmetic of the application arithmetic, to two or more first arithmetic groups among the plurality of arithmetic groups, and assign a second command which is a command for diagnostic arithmetic, to one or more second arithmetic groups among the plurality of arithmetic groups; and
storage areas,
wherein each of the plurality of arithmetic groups includes a plurality of cores and a control system for assigning the same arithmetic command to the plurality of cores;
wherein a surplus core is a core to which the application arithmetic is not assigned;
wherein regarding each of the two or more first arithmetic groups, a used core executes the application arithmetic in accordance with the first command from the control system and stores a result of the application arithmetic in a first storage area which is defined by the second parallel arithmetic program;
wherein regarding each of the two or more first arithmetic groups, a surplus core executes the redundant arithmetic in parallel with the application arithmetic in accordance with the first command from the control system and stores a result of the redundant arithmetic in a second storage area which is defined by the second parallel arithmetic program;
wherein regarding each of the one or more second arithmetic groups, the surplus core executes the diagnostic arithmetic for comparing two or more redundant arithmetic results in the second storage area in accordance with the second command from the control system and stores a result of the diagnostic arithmetic including whether an error exists or not, in a third storage area which is defined by the second parallel arithmetic program;
wherein the application arithmetic result stored in the first storage area is provided to at least one of one or more external systems for the parallel arithmetic device; and
wherein the diagnostic arithmetic result stored in the third storage area is provided to at least one of the one or more external systems for the parallel arithmetic device.

6. The parallel arithmetic device according to claim 5, further comprising an information management unit that manages error management information which is information regarding an error result that is the diagnostic arithmetic result meaning that there is an error.

7. The parallel arithmetic device according to claim 6, further comprising a feature judgment unit configured to judge device feature including at least one of characteristics and status of the parallel arithmetic device on the basis of the error management information,
wherein information representing the judged device feature is provided to at least the one or more external systems.

8. The parallel arithmetic device according to claim 7,
wherein the error management information includes information representing the number of times of errors which is the number of times an error result is obtained with respect to each first command for which the error result is obtained; and
wherein the device feature includes a vulnerable command which is the first command regarding which the number of times of errors is absolutely or relatively large.

9. The parallel arithmetic device according to claim 7,
wherein the error management information includes information representing an error-occurrence time which is a time at which the error result has occurred with respect to each error result; and
wherein the device feature includes an error type in accordance with the length of an interval between an error-occurrence time and a next error-occurrence time.

10. A computer program for causing a parallel arithmetic device including a plurality of arithmetic groups to execute parallel arithmetic of predetermined processing,
the computer program comprising:
information that defines application arithmetic which is arithmetic constituting the predetermined processing,
wherein each of the plurality of arithmetic groups includes a plurality of cores and a control system which assigns a plurality of arithmetic commands to the plurality of cores, and
wherein a surplus core is a core to which the application arithmetic is not assigned;
information that is arithmetic assigned to a surplus core in a first arithmetic group among the plurality of arithmetic groups, and defines redundant arithmetic of the application arithmetic; and
information that defines diagnostic arithmetic which is a comparison of redundant arithmetic results of the same redundant arithmetic by two or more surplus cores possessed by each of two or more first arithmetic groups and is arithmetic assigned to a surplus core in a second arithmetic group among the plurality of arithmetic groups.
